(19) United States
(12) Patent Application Publication
(10) Pub. No.: US 2009/0226026 A1
(43) Pub. Date: Sep. 10, 2009

(54) TECHNIQUES FOR AUDIO AND SPECIAL EFFECTS PRODUCTION

(76) Inventor: Paul M. Krueger, Baltimore, MD (US)

Correspondence Address: Jefferson IP Law, LLP, 1730 M Street, NW, Suite 807, Washington, DC, 20036, US

(21) Appl. No.: 12/399,909

(22) Filed: Mar. 6, 2009

Related U.S. Application Data
(60) Provisional application No. 61/034,398, filed on Mar. 6, 2008.

(51) Int. Cl. H04R 1/02

(52) U.S. Cl. 381/386; 381/345

(57) ABSTRACT

Techniques for audio and special effects production are provided. The techniques may be realized as a loudspeaker apparatus for producing audio and special effects. The apparatus includes at least one electroacoustical transducer having a vibratable diaphragm, an enclosure forming a chamber for supporting the electroacoustical transducer for converting an input electrical signal into a corresponding acoustic signal, an atmospheric effect generator for introducing an atmospheric effect into the enclosure, and at least one port for coupling the chamber to a region outside the enclosure. At least a portion of the atmospheric effect introduced into the chamber may be exhausted to the region outside the enclosure through the at least one port. In addition, the exhausting of the at least a portion of the atmospheric effect may be modulated by the acoustic signal.

### CROSS-REFERENCE TO RELATED APPLICATION

This patent application claims priority to U.S. Provisional Patent Application No. 61/034,398, filed Mar. 6, 2008, which is hereby incorporated by reference herein in its entirety.

### FIELD OF THE DISCLOSURE

The present disclosure relates generally to the field of audio and special effects production. More particularly, the present disclosure relates to techniques for audio and special effects production.

### BACKGROUND OF THE DISCLOSURE

A common objective in designing a loudspeaker system is to improve acoustical performance in the operating band of the system and to minimize distortion caused by, among other things, electroacoustical transducer diaphragm excursions at frequencies below a lower cutoff frequency of the electroacoustical transducer.

In general, when an electroacoustical transducer is energized, its diaphragm (“cone”) reciprocates or vibrates at a frequency which varies with a signal input to the electroacoustical transducer. When an unmounted or unbaffled electroacoustical transducer is operated in a so-called “free air” mode, its diaphragm exhibits large mechanical excursions as it approaches its resonant frequency. These excursions produce significant acoustical distortion. In order to control this motion and thereby reduce the distortion level of the electroacoustical transducer, it is customary to mount the electroacoustical transducer in some form of housing or loudspeaker enclosure.

In its simplest form, this enclosure is a closed box with the electroacoustical transducer mounted or suspended in an opening in one wall of the enclosure. Such a loudspeaker system is referred to as an acoustic suspension system. An acoustic suspension system provides a reactance against which the electroacoustical transducer is driven, which limits the excursion and also prevents the radiation from the back of the electroacoustical transducer from canceling that from the front. In an acoustic suspension system the large amplitudes of the diaphragm excursions occur at a different frequency, thus the resonant frequency of the electroacoustical transducer relative to its resonant frequency in its “free air” mode of operation is changed.

A ported loudspeaker system is one conventional approach to improving upon the acoustic suspension system. A ported loudspeaker system typically includes the electroacoustical transducer mounted in the enclosure which includes a port that serves as a passive radiating means. The air in the port provides an acoustic mass that provides an extra reactance which may be used to tailor the low end frequency response. A ported loudspeaker system is characterized by a resonance (port Q resonance) at which the mass of air in the port reacts with the volume of air in the cabinet to create a resonance at which the diaphragm excursion of the electroacoustical transducer is minimized. A ported loudspeaker system exhibits improved sensitivity at port resonance and decreased diaphragm excursion, thereby minimizing distortion. The result of the improved sensitivity at port resonance is frequently an extension of the lower cutoff frequency of the loudspeaker system to an even lower value.

The characteristics of a ported loudspeaker system are particularly well suited to the task of producing audio, sounds, songs or music at entertainment venues and social events, such as motion picture and television productions, live theatre, concerts, nightclubs and raves, amusement and theme parks, video arcades, and similar venues. At such entertainment venues and social events, special effects, such as lighting effects and atmospheric effects (special effect smoke, fog, haze, etc.), are often utilized in parallel with the production of audio. The atmospheric and lighting effects may be used independently or in conjunction with each other to create a specific sense of mood or atmosphere. Various special effects have been used to enhance other special effects. For example, atmospheric effects may be used for enhancing lighting effects by making lighting and lighting effects visible.

However, up until now, the production of audio and special effects have occurred separately without leveraging the capabilities of one with the other. Thus, while atmospheric effects have been used to enhance lighting effects, the production of audio, such as by a loudspeaker, has not been used to enhance special effects such as atmospheric effects.

In view of the foregoing, it may be understood that there are significant shortcomings associated with current audio and special effects production technologies.

### SUMMARY OF THE DISCLOSURE

Techniques for audio and special effects production are disclosed. In one particular exemplary embodiment, the techniques may be realized as a loudspeaker apparatus for producing audio and special effects. The apparatus includes at least one electroacoustical transducer having a vibratable diaphragm, an enclosure forming a chamber for supporting the electroacoustical transducer for converting an input electrical signal into a corresponding acoustic signal, an atmospheric effect generator for introducing an atmospheric effect into the enclosure, and at least one port for coupling the chamber to a region outside the enclosure. At least a portion of the atmospheric effect introduced into the chamber may be exhausted to the region outside the enclosure through the at least one port. In addition, the exhausting of the at least a portion of the atmospheric effect may be modulated by the acoustic signal.

In yet another particular exemplary embodiment, the techniques may be realized as a method for producing audio and special effects using a loudspeaker, the loudspeaker comprising at least one electroacoustical transducer having a vibratable diaphragm for reproducing audio, an enclosure forming a chamber for supporting the electroacoustical transducer, and at least one port for coupling the chamber to a region outside the enclosure. The method includes introducing an atmospheric effect into the enclosure from an atmospheric effect generator, exhausting at least a portion of the atmospheric effect to the region outside the enclosure through the at least one port, converting an input electrical signal into a corresponding acoustic signal using the electroacoustical transducer, and modulating the exhausting of at least a portion of the atmospheric effect using the acoustic signal.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIG. 1 is a diagrammatic representation of a loudspeaker in accordance with an exemplary embodiment of the present disclosure.

FIG. 2 is a flowchart illustrating the operation of a loudspeaker in accordance with an exemplary embodiment of the present disclosure.

FIGS. 3A and 3B are diagrammatic representations of a loudspeaker in accordance with another exemplary embodiment of the present disclosure.

FIG. 4 is a diagrammatic representation of a loudspeaker in accordance with yet another exemplary embodiment of the present disclosure.

FIGS. 5A and 5B are diagrammatic representations of a loudspeaker in accordance with still another exemplary embodiment of the present disclosure.

### DETAILED DESCRIPTION OF EXEMPLARY EMBODIMENTS

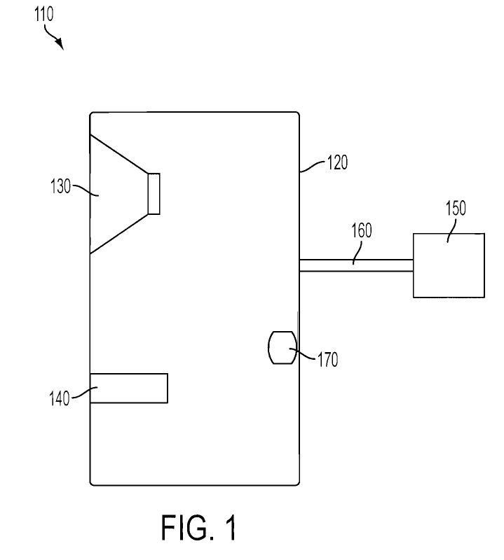

Referring to FIG. 1, there is illustrated a diagrammatic representation of a loudspeaker in accordance with an exemplary embodiment of the present disclosure. The loudspeaker 110 comprises an enclosure 120, an electroacoustical transducer 130, a port 140, an atmospheric effect generator 150, an enclosed channel 160, and a lighting effect generator 170. In an exemplary implementation, one of the atmospheric effect generator 150 and the lighting effect generator 170 may be omitted.

The enclosure 120 comprises at least two openings between the exterior and the interior of the enclosure 120. The enclosure 120 may be constructed using any material suitable for the construction of a speaker enclosure, such as woods, plastics, metals, and the like. Further, the enclosure 120 is not limited to the shape illustrated in FIG. 1 and may be constructed in any shape.

The electroacoustical transducer 130 is mounted to the enclosure 120 at one of the least two openings between the exterior and the interior of the enclosure 120. When the electroacoustical transducer 130 is mounted to the enclosure 120, the opening between the exterior and the interior of the enclosure 120 where the electroacoustical transducer 130 is mounted is substantially sealed to ensure that no air passes through the opening. The electroacoustical transducer 130 may comprise a vibratable diaphragm suspended in a frame. When the electroacoustical transducer 130 is mounted to the enclosure 120 one side of the diaphragm is exposed to the interior of the enclosure 120. The electroacoustical transducer 130 may further comprise a frame, a voice coil and magnet assembly. The internal air volume of the enclosure 120 may be substantially reactive to the acoustic energy generated by the electroacoustical transducer 130 in response to an electrical signal for driving the electroacoustical transducer 130.

While one electroacoustical transducer 130 is illustrated in FIG. 1 and described herein, the present disclose is not limited thereto. The loudspeaker 110 may include any number of electroacoustical transducers 130. Further, the loudspeaker 110 may include any number of passive radiators which are similar to the electroacoustical transducer 130 in that they have a suspended diaphragm, but lack a voice coil and magnet assembly.

The port 140 is disposed at one of the at least two openings of the enclosure 120. The port 140 may alternatively be referred to as a vent or a duct. The port 140 may be integral to the enclosure 120 or may be separately constructed from the enclosure 120 and mounted thereto. When the port 140 is separately constructed from the enclosure 120, the port 140 may be constructed using any material suitable for the construction of a loudspeaker port, such as woods, plastics, metals, and the like. Further, the port 140 is not limited to the shape illustrated in FIG. 1 and may be formed in any shape. In one exemplary implementation, the port may be implemented as an elongated hollow member open at both ends and sized to enclose a selected acoustic mass of air. In another exemplary implementation, the port may be tubular. In addition, while one port 140 is illustrated in FIG. 1 and described herein, the present disclose is not limited thereto. The loudspeaker 110 may include any number of ports 140.

The port 140 may include a port resonance at which the mass of the air in the port reacts with the volume of air within the enclose 120 to create a resonance at which the excursion of the diaphragm of the electroacoustical transducer 130 is minimized. In one exemplary implementation, the loudspeaker 110 is designed so that the port 140 significantly contributes to the overall acoustical output of the loudspeaker 110, which may be accomplished by appropriate selection of various parameters of the loudspeaker 110.

Atmospheric effect generator 150 introduces an atmospheric effect into the interior of the enclosure 120. In one exemplary implementation, pressure in the enclosure increases as atmospheric effect is introduced into the interior of the enclosure 120. The increased pressure thereby causes at least a portion of the atmospheric effect to exhaust outside the enclosure 120 through the port 140. The introduction of the atmospheric effect into the enclosure 120 may occur at a constant rate which may be adjusted. Further, the rate at which the atmospheric effect is introduced into the speaker enclosure may be varied based on a first control signal. The first control signal may, for example, be based on an input electrical signal received at the loudspeaker 110 to drive the electroacoustical transducer 130. In another exemplary implantation the first control signal may, for example, be based on a lighting effect control signal, or may be a signal dedicated to the control of the generation of the atmospheric effect.

The atmospheric effect generator 150 may generate any of various types of atmospheric effect, including smoke effects, fog, liquid Carbon Dioxide (CO₂), Dry Ice (solid CO₂), Liquid Nitrogen (LN₂), Liquid Synthetic Air (Liquid Air), and the like. Exemplary atmospheric effects and atmospheric effect generating techniques are described below.

Smoke effects refer to atmospheric effects produced either by pyrotechnic materials, such as Smoke Cookies, Lycopodium powder and pre-fabricated smoke cartridges; or other, flammable substances such as incense or Heating, Ventilating, and Air Conditioning (HVAC) smoke pencils or pens. Smoke is differentiated from other atmospheric effects in that it is composed of solid particles released during combustion, rather than liquid droplets of which fog or haze are composed.

Fog is created by pumping one of a variety of different glycol or glycol/water mixtures (referred to as fog fluid) into a heat exchanger (a block of metal with a resistance heating element in it) and heating until the fluid vaporizes, thereby creating a thick translucent or opaque cloud. Devices specifically manufactured for this purpose are referred to as fog machines. Another method for creating fog is to use a device known as a thermal fogger that aspirates a petroleum product (typically kerosene or propane), ignites the fuel, and then mixes in air and aspirated petroleum product to create a dense fog. Herein, glycol/water mixtures, or water may alternatively be used.

Fog generated by a fog machine or thermal fogger may be used to create low lying fog effects by combining the fog machine or thermal fogger with another device designed to chill the fog, either by passing the fog through a device containing a fan and ice, or by passing the fog through a device containing a fan and compressor similar to an air conditioner.

Liquid Carbon Dioxide (CO₂), stored in compressed cylinders, may be used in conjunction with a fog machine or thermal fogger to produce “low lying” fog effects. When liquid CO₂ is used to chill fog, the result is a thick fog that remains within a few feet of the ground. As the fog warms, or is agitated, it rises and dissipates. Several manufacturers of fog fluid have developed specially formulated mixtures specifically designed to be used with CO₂, intended to provide thicker, more consistent fog effects. Effect duration is determined by the heating cycle of the fog machine or thermal fogger and consumption rate of liquid CO₂.

Dry Ice (solid CO₂) can also be used in conjunction with a fog machine or thermal fogger to create a low lying fog effect. Dry Ice is placed inside an insulated container with an orifice at each end. Fog from a fog machine is pumped into one side of the container, and allowed to flow out the other end. Although this technique does allow an individual to create low lying fog, the volume of low lying fog produced is typically small, and is more susceptible to atmospheric disturbances.

Haze effects refer to creating an unobtrusive, homogeneous cloud intended primarily to reveal lighting beams, such as the classic “light fingers” in a rock concert. This effect is produced using a haze machine, typically done in one of two ways. One technique uses mineral oil, atomized via a spray pump powered either by electricity or compressed CO₂, breaking the mineral oil into a fine mist. Another technique for creating haze uses a glycol/water mixture to create haze in a process substantially the same as that for creating fog effects. In either case, the fluid used may be referred to as haze fluid, but the different formulations may not be compatible or interchangeable. Glycol/water haze fluid is sometimes referred to as “water based haze.”

Smaller volumes of haze may also be generated from aerosol canisters containing mineral oil under pressure. Although the density of haze generated and the volume of space that can be filled is significantly smaller than that of a haze machine, aerosol canisters have the advantages of portability, no requirements for electricity and finer control over the volume of haze generated.

CO₂ can also be used as an atmospheric effect on its own. When liquid CO₂ is released into the air, typically through an electric solenoid valve to control timing and duration, the carbon dioxide liquid expands into a vapor and condenses the moisture in the air, creating large billowing plumes. When the solenoid valve is closed, the CO₂ vapor rapidly disperses in the air, ending the atmospheric effect nearly instantaneously. This atmospheric effect may be used for a variety of applications, including simulating geysers of steam, in place of pyrotechnics, or to create an instant opaque wall for a reveal or disappearance during magic acts.

Dry Ice (solid CO₂) can also be used as an atmospheric effect on its own. Dry Ice effects are produced by heating water to or near boiling in a suitable container (for example: a container with water heater coils in it), and then dropping in one or more pieces of dry ice. This makes the carbon dioxide sublime (transition directly from solid to gaseous states) very rapidly. The gaseous carbon dioxide condenses water vapor and creates a thick white fog. A fan placed at the top of the container directs the fog where it is needed, creating a rolling fog that lies low to the ground. As the submerged dry ice cools the water, the amount and duration of fog produced will be reduced, requiring “rest” periods to reheat the water.

Liquid Nitrogen (LN₂) is used to create low lying fog effects in a manner similar to Dry Ice. A machine heats water to or near the boiling point, creating steam and increasing the humidity in a closed container. When liquid nitrogen is pumped into the container, the moisture rapidly condenses, creating a thick white fog. A fan placed at the output of the container directs the fog where it is needed, creating a rolling fog that lies low to the ground. These types of machines are commonly referred to as “dry foggers” because the fog created by this method consists solely of water vapor, and as it dissipates there is little to no residue left on any surfaces.

Liquid Synthetic Air (Liquid Air) was developed as an alternative to using LN₂ in generating low lying fog effects. Liquid air is composed of Nitrogen (N₂) and Oxygen (O₂) mixed in a ratio of 79% Nitrogen and 21% Oxygen stored as a liquid in compressed cylinders. Liquid Synthetic Air was developed to be used as a direct replacement for LN₂ in fog effects, with the intent that the inclusion of oxygen in a ratio similar to that found in the atmosphere prevents effects generated with liquid air from becoming a hazard.

While specific atmospheric effects and atmospheric effect generation techniques have been discussed above as examples, the present disclosure is not intended to be limited thereto. The atmospheric effect generator 150 may be any atmospheric effect generator 150 capable of generating any atmospheric effect.

The atmospheric effect generator 150 may be disposed external to the enclosure 120 and may introduce the atmospheric effect into the enclosure 120 through enclosed channel 160. Enclosed channel 160 may be implemented as a tube or pipe. The atmospheric effect generator may be used to generate atmospheric effect for more than one loudspeaker 110. Alternatively, the atmospheric effect generator 150 may be located within the enclosure 120 or may be integral with the enclosure 120.

The lighting effect generator 170 may comprise illumination devices that are disposed within the enclosure 120, within the port 140 and/or disposed on one or more outside portions of the enclosure 120. In one exemplary implementation, the lighting effect generator 170 generates light that is indirectly or directly passed through the port 140 so as to illuminate any atmospheric effect being exhausted via the port. The intensity of the illumination devices may be varied at a constant rate which may be adjusted. Alternatively, the intensity of the illumination devices may be varied based on a second control signal. The second control signal may, for example, be based on the electrical signal input to the loudspeaker 110 to drive the electroacoustical transducer 130, based on a signal dedicated to the control of the generation of the atmospheric effect, or may be a signal dedicated to the generation of the lighting effect. If both interior and exterior illumination devices are utilized, each illumination device may be controlled based on a different control signal or the same control signal. Further, when a plurality of illumination devices are used, each or combination of any number of the illumination devices may be controlled independently or together. The illumination devices may be any one or a combination of light emitting diodes (LEDs), incandescent devices, florescent devices, or the like.

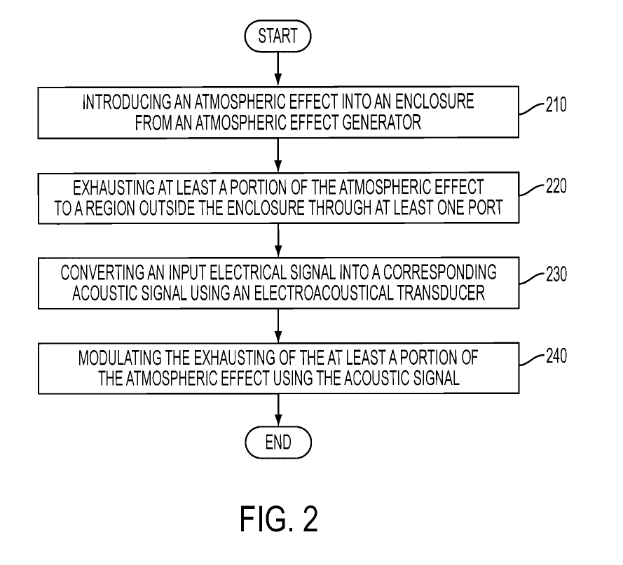

Referring to FIG. 2, a flowchart illustrates an operation of a loudspeaker in accordance with an exemplary embodiment of the present disclosure. For convenience of description, FIG. 2 will be described with reference to the loudspeaker 110 of FIG. 1 described above. However, the method illustrated in FIG. 2 is applicable to any other ported loudspeaker having an atmospheric effect introduced therein.

In step 210, an atmospheric effect is introduced into an enclosure from an atmospheric effect generator. In step 220, at least a portion of the atmospheric effect is exhausted to a region outside the enclosure through at least one port. In step 230, an input electrical signal is converted into a corresponding acoustic signal using an electroacoustical transducer. In step 240, the exhausting of the at least a portion of the atmospheric effect is modulated using the acoustic signal. While the method illustrated in FIG. 2 has been described as having various steps, the steps do not have to occur in the order described herein and any number of the steps may occur simultaneously or may overlap in time.

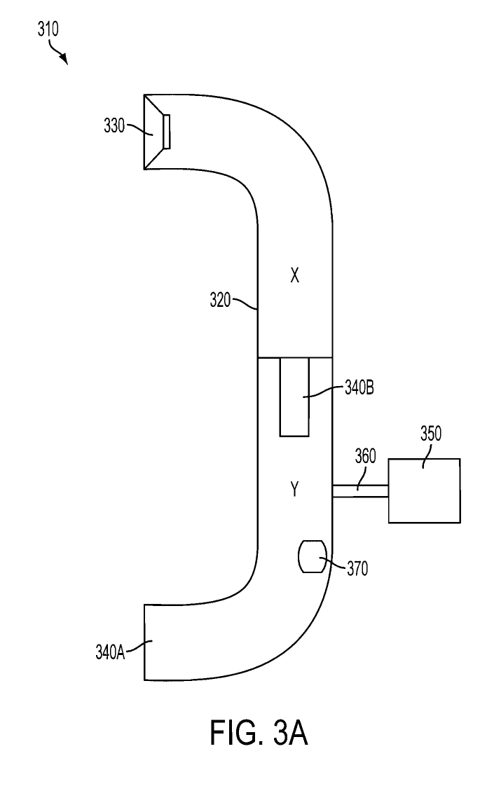

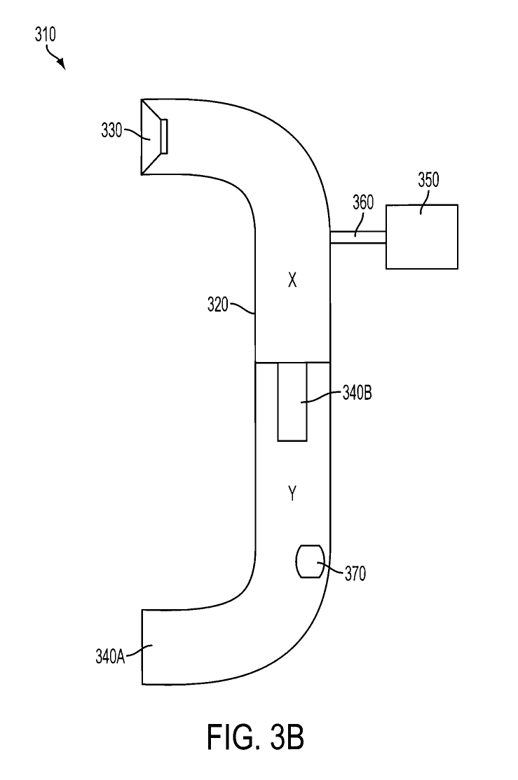

The above techniques may be applied to any one of the various exemplary embodiments disclosed in U.S. Patent App. Pub. No. 2007/0284184, which is hereby incorporated by reference herein in its entirety. Examples of above techniques applied to various embodiments disclosed in U.S. Patent App. Pub. No. 2007/0284184 and discussed hereafter with reference to FIGS. 3A-5B.

Referring to FIGS. 3A and 3B, there are illustrated diagrammatic representations of a loudspeaker in accordance with another exemplary embodiment of the present disclosure. The loudspeaker 310 comprises an enclosure 320, an electroacoustical transducer 330, a port 340A, an internal port 340B, an atmospheric effect generator 350, an enclosed channel 360, and a lighting effect generator 370. The techniques discussed with respect to FIGS. 1 and 2 are equally applicable to loudspeaker 310 of FIGS. 3A and 3B. Loudspeaker 310 of FIGS. 3A and 3B differ from loudspeaker 110 of FIG. 1 by virtue of a tubular shape of enclosure 320 and internal port 340B within enclosure 320 that bisects the interior of enclosure 320 to forms portions X and Y.

Atmospheric effect generator 350 may introduce the atmospheric effect into interior portion Y of enclosure 320 as illustrated in FIG. 3A. Alternatively, atmospheric effect generator 350 may introduce the atmospheric effect into the interior portion X of enclosure 320 as illustrated in FIG. 3B. In either case, the atmospheric effect will ultimately be exhausted from port 340A, wherein the exhausting of the atmospheric effect is modulated by an acoustic signal generated when electroacoustical transducer 330 is driven by an input electrical signal. Port 340A is substantially the same diameter as the diameter of a cross section of enclosure 320 that is perpendicular to a path taken by the acoustic energy within enclosure 320.

While atmospheric effect generator 350 is illustrated in FIGS. 3A and 3B as being disposed outside enclosure 320, atmospheric effect generator 350 may be disposed within interior portions X or Y of enclosure 320 or may be integral with enclosure 320. Herein, enclosed channel 360 may be omitted. Further, while lighting effect generator 370 is illustrated in FIGS. 3A and 3B as being disposed within enclosure 320 near port 340A, lighting effect generator 370 may be located elsewhere. In an exemplary implementation, one of the atmospheric effect generator 350 and the lighting effect generator 370 may be omitted.

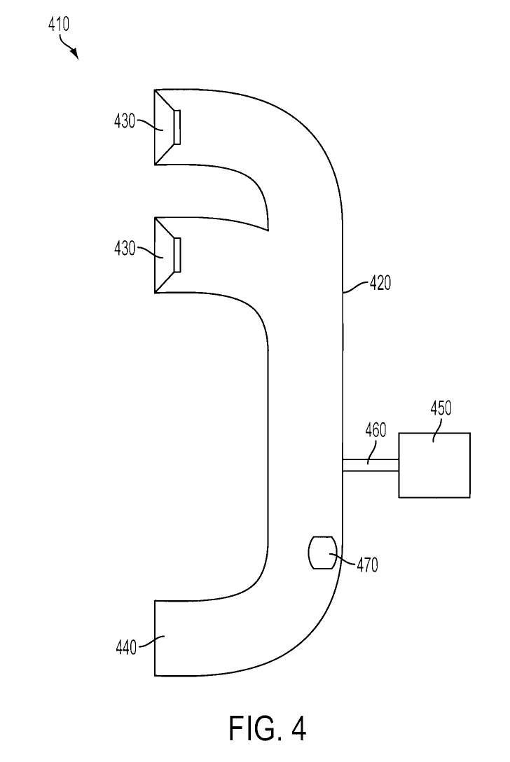

Referring to FIG. 4, there is illustrated a diagrammatic representation of a loudspeaker in accordance with yet another exemplary embodiment of the present disclosure. The loudspeaker 410 comprises an enclosure 420, two electroacoustical transducers 430, a port 440, an atmospheric effect generator 450, an enclosed channel 460, and a lighting effect generator 470. The techniques discussed with respect to FIGS. 1 and 2 are equally applicable to loudspeaker 410 of FIG. 4. Loudspeaker 410 of FIG. 4 differs from loudspeaker 110 of FIG. 1 by virtue of a tubular shape of enclosure 320 and that there are two electroacoustical transducers 430.

The atmospheric effect is generated by atmospheric effect generator 450 and introduced into enclosure 420. The atmospheric effect is exhausted from port 440, wherein the exhausting of the atmospheric effect is modulated by an acoustic signal generated when electroacoustical transducers 430 are driven by an input electrical signal. Port 440 is substantially the same diameter as the diameter of a cross section of enclosure 420 that is perpendicular to a path taken by the acoustic energy within enclosure 420.

While atmospheric effect generator 450 is illustrated in FIG. 4 as being disposed outside enclosure 420, atmospheric effect generator 450 may be disposed within enclosure 420 or may be integral with enclosure 420. Herein, enclosed channel 460 may be omitted. Further, while lighting effect generator 470 is illustrated in FIG. 4 as being disposed within enclosure 420 near port 440, lighting effect generator 470 may be located elsewhere. In an exemplary implementation, one of the atmospheric effect generator 450 and the lighting effect generator 470 may be omitted.

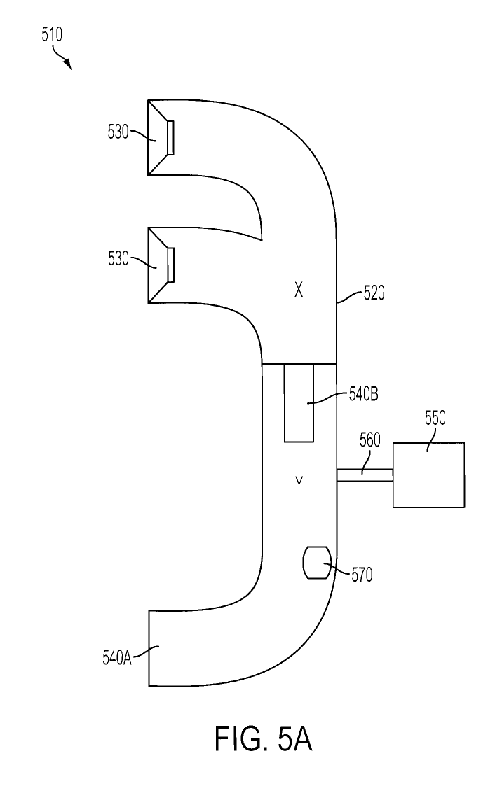

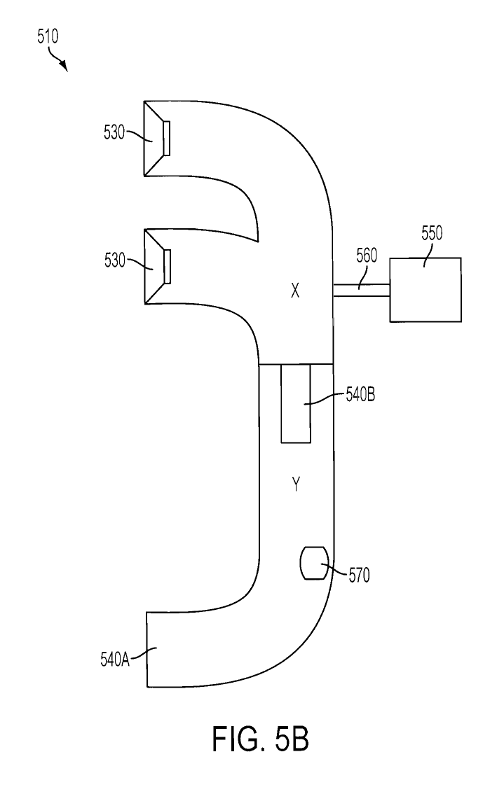

Referring to FIGS. 5A and 5B, there are illustrated diagrammatic representations of a loudspeaker in accordance with yet another exemplary embodiment of the present disclosure. The loudspeaker 510 comprises an enclosure 520, two electroacoustical transducers 530, a port 540A, an internal port 540B, an atmospheric effect generator 550, an enclosed channel 560, and a lighting effect generator 570. The techniques discussed with respect to FIGS. 1 and 2 are equally applicable to loudspeaker 510 of FIGS. 5A and 5B. Loudspeaker 510 of FIGS. 5A and 5B differ from loudspeaker 110 of FIG. 1 by virtue of a tubular shape of enclosure 520, that there are two electroacoustical transducers 530, and internal port 540B within enclosure 520 that bisects the interior of enclosure 520 to forms portions X and Y.

Atmospheric effect generator 550 may introduce the atmospheric effect into interior portion Y of enclosure 520 as illustrated in FIG. 5A. Alternatively, atmospheric effect generator 550 may introduce the atmospheric effect into the interior portion X of enclosure 520 as illustrated in FIG. 5B. In either case, the atmospheric effect will ultimately be exhausted from port 540A, wherein the exhausting of the atmospheric effect is modulated by an acoustic signal generated when electroacoustical transducers 530 are driven by an input electrical signal. Port 540A is substantially the same diameter as the diameter of a cross section of enclosure 520 that is perpendicular to a path taken by the acoustic energy within enclosure 520.

While atmospheric effect generator 550 is illustrated in FIGS. 5A and 5B as being disposed outside enclosure 520, atmospheric effect generator 550 may be disposed within interior portions X or Y of enclosure 520 or may be integral with enclosure 520. Herein, enclosed channel 560 may be omitted. Further, while lighting effect generator 570 is illustrated in FIGS. 5A and 5B as being disposed within enclosure 520 near port 540A, lighting effect generator 570 may be located elsewhere. In an exemplary implementation, one of the atmospheric effect generator 550 and the lighting effect generator 570 may be omitted.

Exemplary embodiments of the present disclosure, combine audio and special effects production to produce a combined effect wherein the loudspeaker exhausts an atmospheric effect such as smoke, fog, or haze, via a port and wherein the exhausting of the atmospheric effect is modulated by acoustic energy from an electroacoustical transducer. Additionally, the atmospheric effect being exhausted via the port may be illuminated from within the loudspeaker. The combined effect creates a specific sense of mood or atmosphere that is not achievable when the audio and special effects are separately produced.

The present disclosure is not to be limited in scope by the specific exemplary embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A loudspeaker apparatus for producing audio and special effects, the apparatus comprising:
at least one electroacoustical transducer having a vibratable diaphragm;
an enclosure forming a chamber for supporting the electroacoustical transducer for converting an input electrical signal into a corresponding acoustic signal;
an atmospheric effect generator for introducing an atmospheric effect into the enclosure; and
at least one port for coupling the chamber to a region outside the enclosure,
wherein at least a portion of the atmospheric effect introduced into the chamber is exhausted to the region outside the enclosure through the at least one port, and further wherein the exhausting of the at least a portion of the atmospheric effect is modulated by the acoustic signal.

2. The apparatus of claim 1, wherein the chamber and the at least one port are configured for establishing a resonance at a frequency for minimizing excursion of the diaphragm at the frequency.

3. The apparatus of claim 1, wherein the at least one port comprises an acoustic mass that constitutes an extra reactance that is used to tailor a low end of a frequency response of the loudspeaker apparatus.

4. The apparatus of claim 1, wherein the atmospheric effect comprises at least one of smoke, fog and haze.

5. The apparatus of claim 1, wherein the atmospheric effect generator comprises at least one of a fog machine, a thermal fogger, and a haze machine.

6. The apparatus of claim 1, wherein the atmospheric effect generator is disposed outside the enclosure.

7. The apparatus of claim 1, wherein the atmospheric effect generator is disposed within the enclosure.

8. The apparatus of claim 1, wherein the introducing of the atmospheric effect into the enclosure increases a pressure within the speaker enclosure thereby causing the exhausting of the at least a portion of the atmospheric effect.

9. The apparatus of claim 1, wherein a rate of the introduction of the atmospheric effect into the enclosure by the atmospheric effect generator is varied based on the input electrical signal.

10. The apparatus of claim 1, further comprising a lighting effect generator for illuminating the atmospheric effect being exhausted through the at least one port.

11. The apparatus of claim 9, wherein the lighting effect generator varies an intensity of the illumination of the atmospheric effect being exhausted through the at least one port based on the input electrical signal.

12. A method for producing audio and special effects using a loudspeaker, the loudspeaker comprising at least one electroacoustical transducer having a vibratable diaphragm for reproducing audio, an enclosure forming a chamber for supporting the electroacoustical transducer, and at least one port for coupling the chamber to a region outside the enclosure, the method comprising:
introducing an atmospheric effect into the enclosure from an atmospheric effect generator;
exhausting at least a portion of the atmospheric effect to the region outside the enclosure through the at least one port;
converting an input electrical signal into a corresponding acoustic signal using the electroacoustical transducer; and
modulating the exhausting of the at least a portion of the atmospheric effect using the acoustic signal.

13. The method of claim 12, wherein the atmospheric effect comprises at least one of smoke, fog and haze.

14. The method of claim 12, wherein the atmospheric effect generator comprises at least one of a fog machine, a thermal fogger, and a haze machine.

15. The method of claim 12, wherein the introducing of the atmospheric effect into the enclosure increases a pressure within the speaker enclosure thereby causing the exhausting of the at least a portion of the atmospheric effect.

16. The method of claim 12, wherein a rate of the introduction of the atmospheric effect into the enclosure by the atmospheric effect generator is varied based on the input electrical signal.

17. The method of claim 12, further comprising illuminating the atmospheric effect being exhausted through the at least one port.

18. The method of claim 17, wherein the illumination of the atmospheric effect being exhausted through the at least one port is varied based on the input electrical signal.
